(19) United States
(12) Patent Application Publication
(10) Pub. No.: US 2005/0283593 A1
(43) Pub. Date: Dec. 22, 2005

(54) Loop end prediction

(76) Inventors: Vladimir Vasekin, Cambridge (GB); Andrew Christopher Rose, Cambridge (GB); Stuart David Biles, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 10/870,548

(22) Filed: Jun. 18, 2004

(51) Int. Cl. G06F 9/00

(52) U.S. Cl. 712/240

(57) ABSTRACT

A branch prediction mechanism within a pipelined processing apparatus uses a history value HV which records preceding branch outcomes in either a first mode or a second mode. In the first mode respective bits within the history value represent a mixture of branch taken and branch not taken outcomes. In the second mode a count value within the history value indicates a count of a contiguous sequence of branch taken outcomes.

### BACKGROUND OF THE INVENTION

1. Field of the Invention

This invention relates to the field of data processing systems. More particularly, this invention relates to pipelined data processing systems incorporating branch prediction mechanisms with loop end prediction capabilities.

2. Description of the Prior Art

It is known to provide pipelined data processing systems in which a plurality of program instructions are simultaneously undergoing respective different portions of their overall execution at different stages within the instruction pipeline. Such mechanisms allow a degree of parallelism to be achieved and thus improve the data processing performance of the system concerned.

A problem within such pipelined data processing systems is that when the program includes a condition branch instruction then a determination must be made as to whether or not that branch will be taken for the purposes of determining which instructions to fetch and place into the instruction pipeline before the conditional branch instruction reaches a point in the pipeline at which it is actually known whether or not the branch will be taken. If the wrong assumption is made, then incorrect following instructions will have been fetched into the instruction pipeline and the processing will have to be stopped, the pipeline flushed and the correct instructions fetched into the pipeline before processing is restarted. This represents a significant processing performance penalty.

In order to try to reduce the problems associated with conditional branch instructions, it is known to provide branch prediction mechanisms which serve to predict whether or not a particular conditional branch instructions will or not be taken in dependence upon the past behavior of the system or the past execution of that particular conditional branch instruction. One known way of performing such branch prediction is to use so called “global history” mechanisms in which predictions concerning whether or not particular conditional branch instructions will or will not be taken are stored within a prediction memory and those predictions are updated depending upon the actual outcome of the conditional branch instruction when this is known. The predictions stored within the prediction memory are typically indexed using one or more of the pattern of outcomes of preceding a conditional branch instruction and portions of the program counter value or combinations thereof. Generally speaking, the greater the amount of resource, typically in terms of gate count and complexity, that is devoted to the branch prediction mechanisms the more accurate these can become. However, size and complexity of the branch prediction mechanisms brings with it disadvantages in terms of cost and power consumption.

A particular problem within the field of branch prediction is accurately predicting loop ends. It is common that program code will include loops which may be executed many times in succession. Such loops typically end with a conditional branch back to the beginning of the loop with that conditional branch being taken many times until the program flow eventually drops out of the loop. It is difficult for global history type mechanisms looking at the immediately preceding pattern of outcomes of conditional branches to readily deal with such loops which are taken a large number of times since a correspondingly large history value and prediction memory needs to be provided to deal with such loops. An alternative approach is to provide a specific mechanism directed toward identifying and predicting loop ends. Such mechanisms may, for example, rely upon the compilers generating specific conditional branch instructions associated with loop program code so that these specific conditional branch instructions may be identified by the hardware and then a count recorded of how many times they are executed before the loop terminates. Once this has been determined, it may be used as a prediction for that loop when it is encounted again. A disadvantage with this approach is that the cost and complexity associated with the provision of these special purpose loop end prediction mechanisms renders them less advantageous overall.

### SUMMARY OF THE INVENTION

According to one aspect the present invention provides apparatus for processing data, said apparatus comprising:

a pipelined processing circuit operable to execute program instructions including conditional branch instructions generating branch outcomes; and

a branch prediction circuit operable to generate predictions of branch outcomes of conditional branch program instructions to be executed by said pipelined processing circuit; and

a prefetch circuit operable to supply a stream of program instructions to said pipelined processing circuit for execution in dependence upon said predictions; wherein

said branch prediction circuit comprises:

a branch history register operable to store a branch history value indicative of a preceding sequence of branch outcomes;

a branch prediction memory having prediction memory storage locations addressed in dependence upon at least said branch history value, a prediction memory storage location addressed by a given branch history value being operable to store a prediction of a branch outcome for a next conditional branch instruction following a given preceding sequence of branch outcomes corresponding to said given branch history value; and

a history value generating circuit operable to generate a history value to be stored within said history register in dependence upon a new branch outcome generated by execution of a new conditional branch instruction by said pipelined processing circuit in accordance with:

a first history value mode in which a stored history value represents a preceding sequence of conditional branch instructions that resulted in a mixture of branch taken outcomes and branch not taken outcomes by respective bits within said history value; and

a second history value mode in which a stored history value represents a preceding sequence of conditional branch instructions that resulted in a continuous sequence of branch taken outcomes of greater than a predetermined length by a count value within said history value.

The present technique recognizes that a single prediction memory can be used in more than one way and switched between modes that are respectively suited to recording information associated with preceding mixtures of branch outcomes so as to predict a new outcome and situations in which a loop is being executed repeatedly with a large number of branch taken outcomes that can be efficiently stored as a count value rather than a sequence of bits each bit representing an individual branch outcome. Thus, the branch prediction mechanism is able to give prediction results for loops which are executed a large number of times without a significant increase in circuit complexity or cost.

In preferred embodiments the branch prediction mechanism switches between the first history value mode and the second history value mode when a continuous sequence of branch taken outcomes occurs exceeding a predetermined number. Thus, for example, individual bits may be used within the history value to separately represent different outcomes until all of those bits have been utilized, whereupon a switch may be made, if the results are all branch takens corresponding to loop behavior, to a mode in which a count of the branch taken outcomes is recorded with the history value rather than individual outcomes.

When a branch not taken outcome is detected, this corresponds to a loop end and accordingly the history value update circuit will advantageously switch back from the second mode into the first mode.

Within preferred embodiments the first mode serves to update the history value by shifting the history value one bit position from a first end towards a second end and adding in a new bit representing the latest branch outcome at the first end. A consequence of this is that the most significant and accurate for use in prediction portion of the history value tends to be the portion close to the first end of the history value within this mode of operation. Having recognized this property, the present technique arranges that the count value used within the second mode extends from the second end of the history value toward the first end as it is incremented. Thus, the most useful prediction values stored within the prediction memory in respect of the first mode of operation will tend not to be overwritten by prediction values corresponding to the second mode of operation with these instead tending to be placed within relatively little used indexed locations within the prediction memory for the first mode.

This use of otherwise little used prediction memory storage locations is further improved if the portion of the history value within the second mode from the most significant bit of the count value towards the first end of the history value is filled with branch not taken representing bits since long sequences of branch not taken outcomes are statistically relatively uncommon within normal program code and so unlikely to be used within the first mode to store useful predictions.

Viewed from another aspect the present invention provides a method of processing data, said method comprising the steps of:

executing program instructions including conditional branch instructions generating branch outcomes with a pipelined processing circuit; and

generating predictions of branch outcomes of conditional branch program instructions to be executed by said pipelined processing circuit with a branch prediction circuit; and

supplying a stream of program instructions to said pipelined processing circuit for execution in dependence upon said predictions with a prefetch circuit; wherein said step of prediction comprises:

storing a branch history value indicative of a preceding sequence of branch outcomes;

addressing prediction memory storage locations within a branch prediction memory in dependence upon at least said branch history value, a prediction memory storage location addressed by a given branch history value being operable to store a prediction of a branch outcome for a next conditional branch instruction following a given preceding sequence of branch outcomes corresponding to said given branch history value; and

generating a history value to be stored within said history register in dependence upon a new branch outcome generated by execution of a new conditional branch instruction by said pipelined processing circuit in accordance with:

a first history value mode in which a stored history value represents a preceding sequence of conditional branch instructions that resulted in a mixture of branch taken outcomes and branch not taken outcomes by respective bits within said history value; and

a second history value mode in which a stored history value represents a preceding sequence of conditional branch instructions that resulted in a continuous sequence of branch taken outcomes of greater than a predetermined length by a count value within said history value.

end toward said first end.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a portion of a data processing apparatus including a prefetch unit, pipeline processing circuits and a branch prediction mechanism;

FIGS. 2 and 3 schematically represent history values used by the branch prediction mechanism in accordance with a first mode of operation and a second mode of operation;

FIG. 4 is a flow diagram schematically illustrating the operations performed when a conditional branch instruction is received into the instruction pipeline;

FIG. 5 is a flow diagram schematically illustrating the actions performed when a branch instruction is executed and the outcome known;

FIG. 6 illustrates how an index value for referencing the prediction value memory is formed from a combination of the history value and the program counter value; and

FIG. 7 illustrates one example of a sequence of history values which can occur when switching from the first mode to the second mode and then back to the first mode.

### DESCRIPTION OF THE PREFERRED EMBODIMENTS

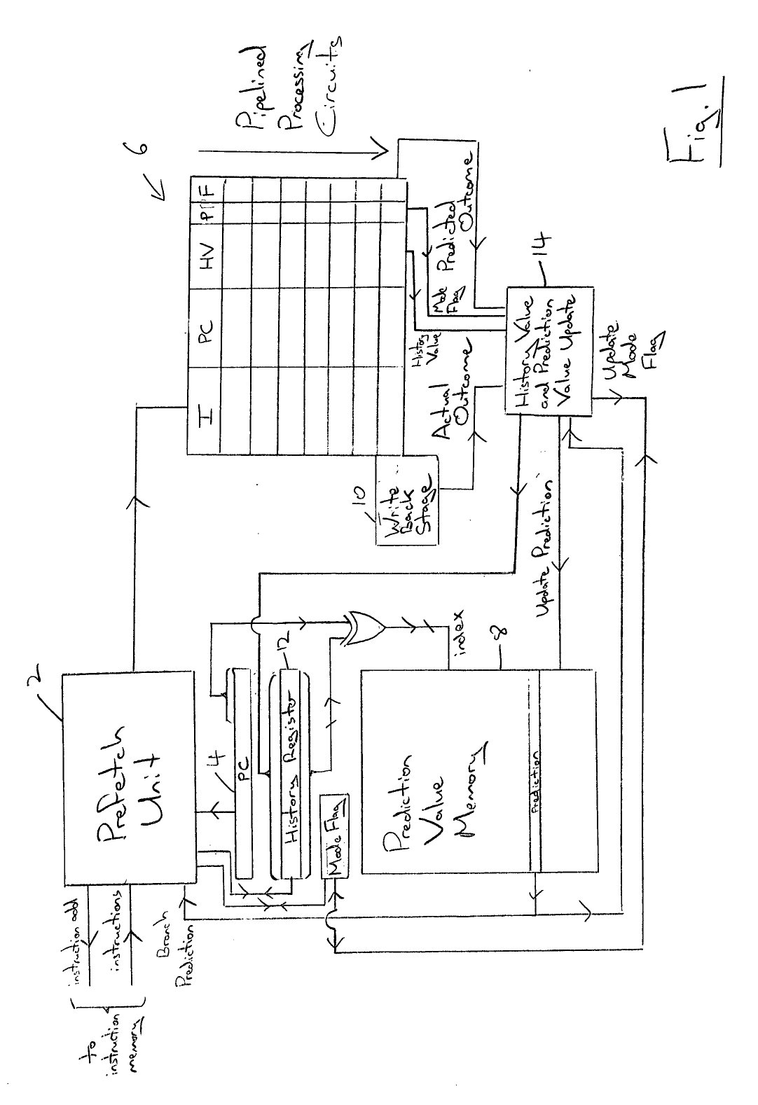

FIG. 1 schematically represents a portion of a data processing circuit including a prefetch unit 2, which serves to fetch program instructions to be executed from an instruction memory. These instructions are stored at respective instruction memory addresses within the instruction memory and the prefetch unit is supplied with a program counter value from a program counter register 4 to direct the fetching of instructions. The instructions are fetched in a contiguous sequence until a branch instruction causes a branch in program flow and triggers fetching from a new instruction memory address and an update of the program counter register 4 to reflect the branch in program flow.

The instructions which may be executed also include conditional branch instructions for which it is not known whether or not a branch in program flow will be the actual outcome until they have progressed someway down the pipeline processing circuits 6. Accordingly, when the condition branch instruction first enters the pipeline a prediction is made as to whether or not that conditional branch instruction will or will not result in a branch in program flow and subsequent fetching of instructions by the prefetch unit 2 is based upon this prediction. If the prediction is wrong, then the pipelined processing circuits 6 must be stopped, flushed and refilled in accordance with normal techniques.

The system of FIG. 1 includes a branch prediction mechanism which comprises a plurality of different portions. Some of the functionality of the branch prediction mechanism is provided by the prefetch unit 2 which has other functions as referred to above. Other functions of the branch prediction mechanisms are provided by dedicated circuit elements, such as the prediction value memory 8. The branch prediction circuitry can thus be considered to be distributed across a variety of circuit elements which may be otherwise known within the system.

Instructions fetched by the prefetch unit 2 are issued into the pipeline processing circuits 6 where they progress along the pipeline stages until they reach a stage at which it is appropriate to consider the branch outcome to be fixed, such as a write back stage 10. A history register 12 serves to store a history value in accordance with either a first mode of operation or a second mode of operation as will be discussed in more detail below. The current history value at the time at which an instruction is launched into the pipelined processing circuit 6 is also stored within the pipeline processing circuits 6 and progresses along the pipeline in step with its associated instruction. This history value can then be used to reference the prediction stored within the prediction value memory 8 used when the instruction entered the pipeline when the actual outcome is known so as to update that prediction value.

As well as the history value accompanying the instruction along the pipelined processing circuit 6, there is also provided the corresponding program counter value, the prediction that was made and a flag indicating whether or not the branch prediction circuitry was operating in the first mode or the second mode at the time at which that prediction was made. All of these values together with the actual outcome of the branch known at the write back stage are supplied to a history value and prediction value update circuit 14 when the instruction reaches the write back stage and are used to index into the prediction value memory 8 and to update the prediction value based upon the actual outcome. The prediction value may be stored as a simple binary taken or not taken result, or alternatively can be stored in a multi-bit representation which indicates, for example, strongly taken, weakly taken, weakly not taken and strongly not taken.

Returning to the action of the branch prediction circuit at the time at which the conditional branch instruction is being launched into the pipeline processing circuit 6, the history value within the history registry 12 representing the immediately preceding sequence of conditional branch instructions is read together with a least significant bit portion of the program counter value and these are XORed together to produce an index value which addresses the prediction value memory 8 to reference a prediction value result which is used to control whether or not the prefetch unit 2 assumes that the conditional branch instruction either will be taken or will not be taken. The prediction value memory 8 is initialized to a known state, such as all of the prediction values being set to a weakly taken indicator.

When the prediction has been made and the conditional branch instruction launched into the pipeline processing circuit 6 together with its program counter value, history value, prediction, and mode flag, the history value and mode flag are updated to reflect the prediction that has been made. In the first mode of update operation, this is achieved by left shifting the history value one bit position and adding the new bit representing the branch outcome at the rightmost end of the history value. In the second mode of operation indicated when the mode flag is set, the history value is updated using the portion of the history value at the leftmost end to represent a multi-bit count value with that count representing the number of successive branch taken outcomes. The effective endianess of the history value may also be reversed. A switch is made from the first mode to the second mode when a sequence of branch taken outcomes has been stored within the first mode completely filling the history register 12. A return from the second mode to the first mode is made when a branch not taken outcome is predicted, or is detected, following a sequence of branch taken outcomes.

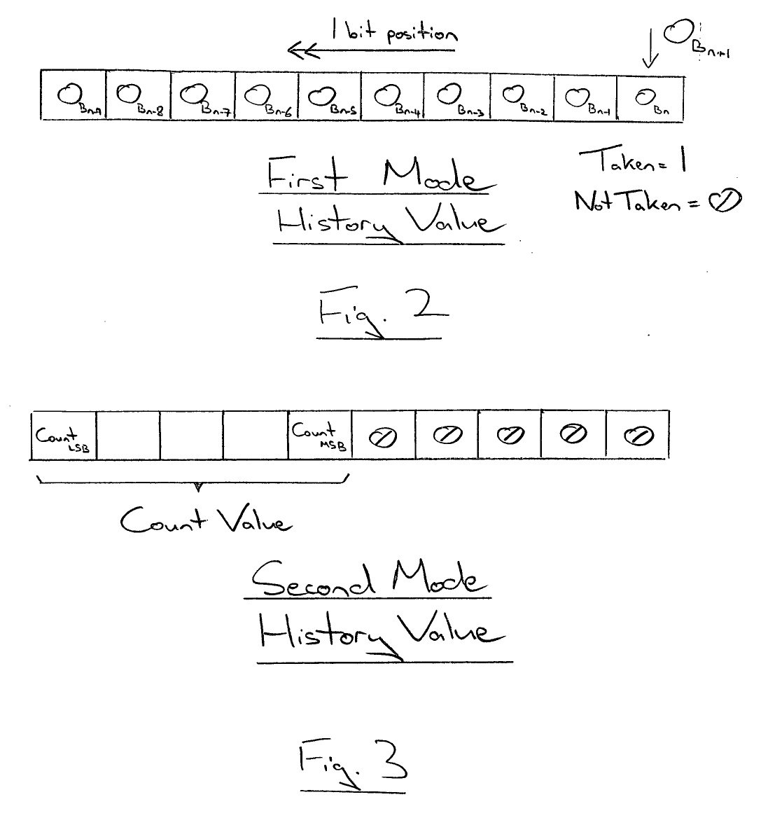

FIG. 2 schematically illustrates the history value representation within the first mode. As will be seen the various outcome values O corresponding to different conditional branch instructions “Bₙ” are recorded in respective bit positions. This history value is updated by a one bit position left shift with a new value being added at the right most bit position.

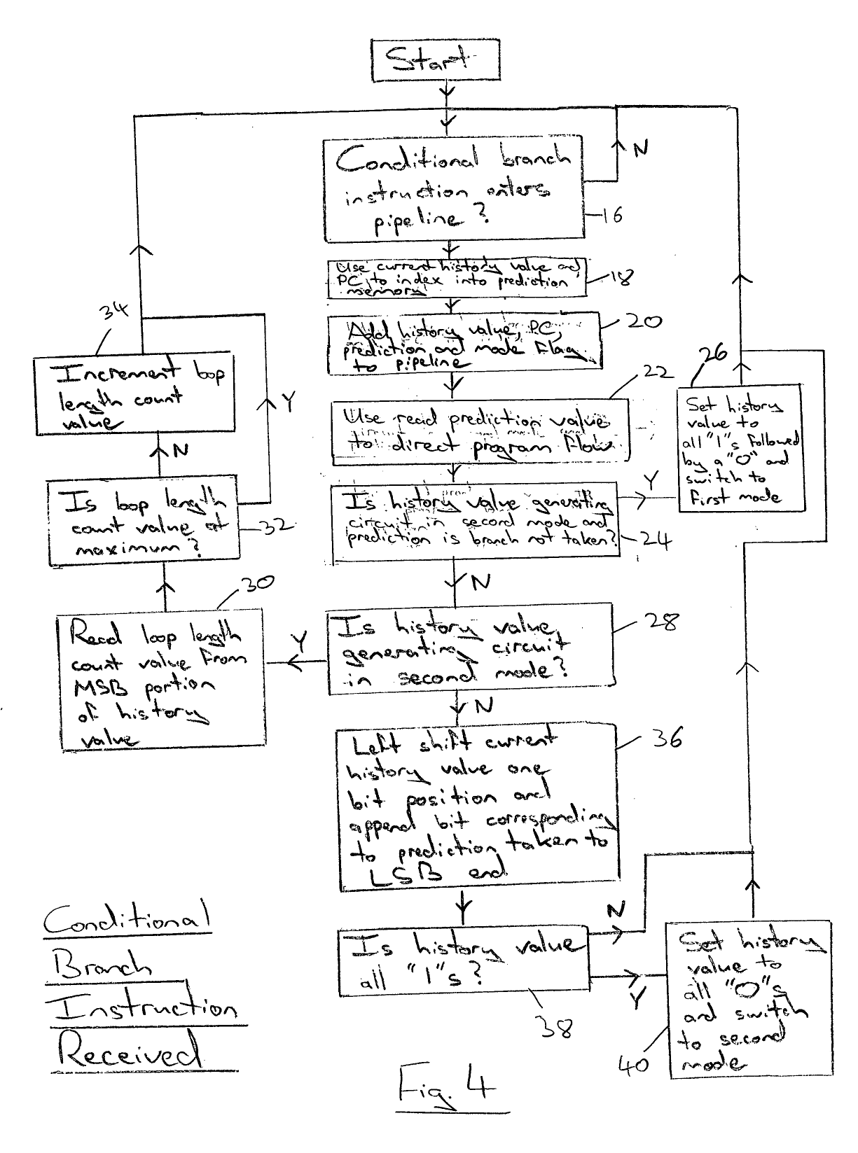

FIG. 3 schematically illustrates the second mode of history value. In this mode the five rightmost bits of the history value are used to represent a count of the number of successive branch taken outcomes. The leftmost five bits of the history value are all set to a bit value corresponding to a branch not taken outcome since prediction values stored at memory locations indexed with the leftmost bits all set to a not taken outcome are statistically unlikely to be storing useful information within the first mode of operation.

FIG. 4 is a flow diagram illustrating the actions of the prefetch unit 2 and the branch prediction circuitry when a branch instruction is received and added to the pipeline processing circuits 6. At step 16, the system waits for a conditional branch instruction to be received and entered the pipeline. At step 18 the current history value and a portion of the program counter value is used to derive an index value which indexed into the prediction memory and references a prediction value used to determine whether or not a predicted branch taken or branch not taken outcome will be assumed by the prefetch unit 2. At step 20 the history value within the history register 12, as used at step 18, the program counter value PC, the prediction recovered P and the mode flag F indicating the current mode of history value are recorded into the pipeline together with the conditional branch instruction I such that these values will move along the pipeline in step with their associated branch instruction and so be available for use in updating and/or correcting the prediction value when the actual outcome is known.

At step 22 the prediction value is used to direct program flow, and in particular to indicate the next instruction to be fetched by the prefetch unit 2.

At step 24, the system determines whether or not it is currently using a history value recorded in accordance with the second mode and simultaneously a branch not taken outcome has been predicted. If this is the case, then processing proceeds to step 26 at which the history value is reverted to the first mode and is written to a value corresponding to all “1”s followed by a single “0” representing a contiguous sequence of branch taken outcomes followed by a single branch not taken outcome and the mode flag is changed to indicate the first mode of history value representation. Step 26 is followed by a return to step 16.

If the determination at step 24 is negative, then processing proceeds to step 28 at which a determination is made as to whether or not the history value is being represented in accordance with a second mode. If this determination is positive, then processing proceeds to step 30 at which the loop length count stored within the count value portion of the history value (see FIG. 3) is read. Step 32 then determines whether or not this count value is currently at its maximum permitted value, i.e. the count value is saturated. If the count value is not saturated, then step 34 increments the count value to indicate that a further branch taken outcome has been predicted and the loop length should be increased by one.

If the determination at step 28 was negative, then the system is using the first mode of recording history value and accordingly step 36 serves to update the history value by left shifting the current history value one bit position and appending a bit corresponding to the prediction taken at the rightmost end of the history value. Step 38 then determines whether or not the current history value is an all “1”s value indicating a maximum run of branch taken outcomes that can be represented in the first mode and accordingly that a switch should be made into the second mode. If such a condition is detected, then step 40 switches into the second mode, by setting the mode flag, and sets the history value to all “0”s before processing is returned to step 16.

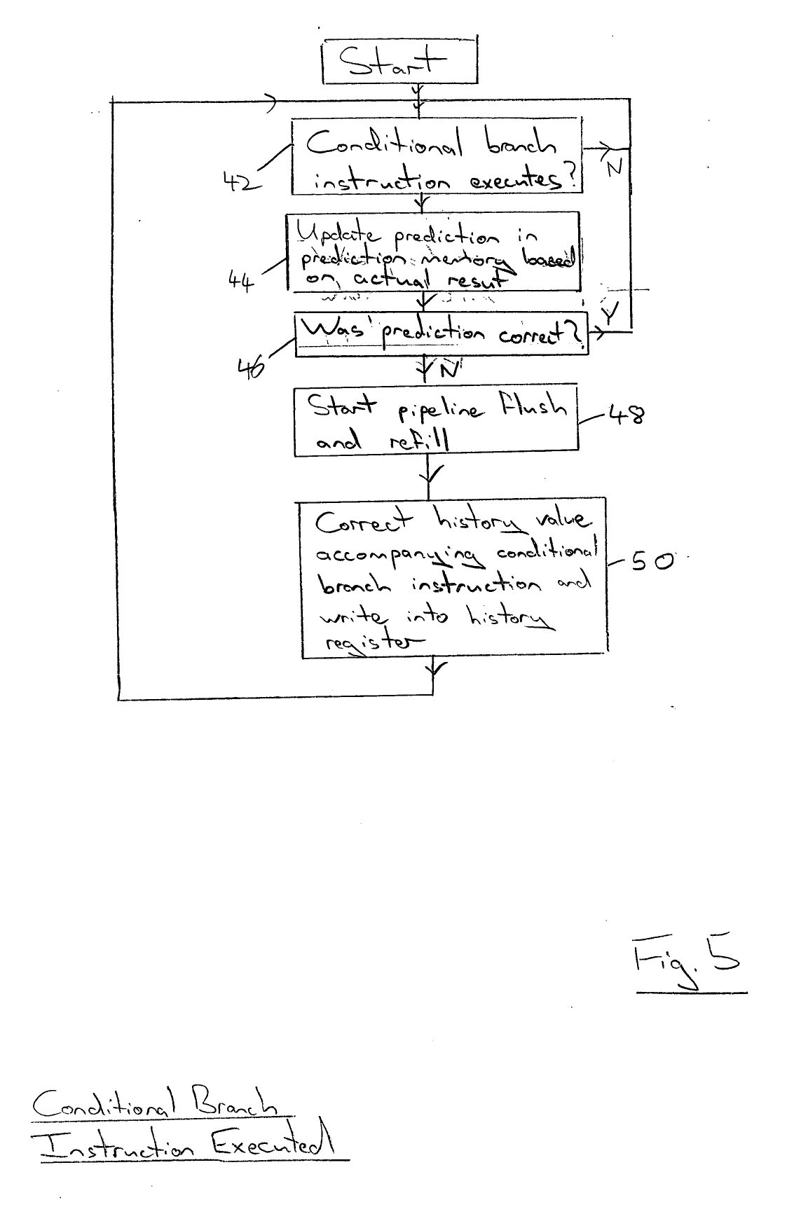

FIG. 5 is a flow diagram schematically illustrating the updating of the prediction values stored within a prediction value memory which takes place when the actual outcome of the branch is known.

Step 42 detects when a conditional branch instruction executes and its outcome is known. Processing then proceeds to step 44 at which the history value and program counter value which accompanied that conditional branch instruction along the pipeline processing circuit 6 is used to index into the prediction value memory 8 and the prediction value stored therein at the index location is updated in dependence upon the actual outcome. The updating performed will indicate more strongly the behavior that actually resulted up to the point at which this indication is saturated within the prediction value. If the prediction value stored was a misprediction, then this misprediction is also compensated for by the update performed in step 44.

Step 46 determines if the prediction value which was used matched the actual; outcome and if this was the case, then processing returns to step 42. If the prediction was a misprediction, then step 48 triggers a pipeline flush and refill. Step 50 then corrects the history value within the history value register 12 to reflect the prediction which is now being enforced upon the conditional branch instruction as reflected in the new sequence of program instructions that are fetched into the pipeline processing circuit 6 by the prefetch unit 2. Processing then returns to step 42.

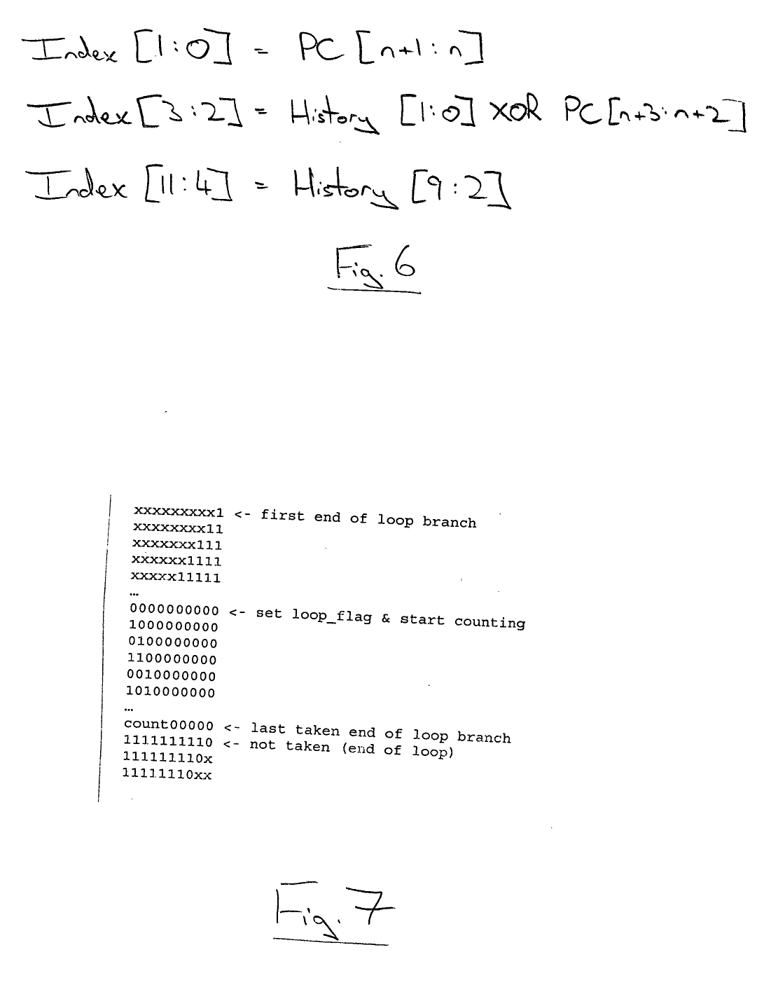

FIG. 6 illustrates how the index value used to index into the prediction value memory 8 may be formed from a combination of the history value within the history register 12 and a portion of the program counter PC value.

FIG. 7 illustrates a sequence of history values that may be stored within a 10-bit history value in the history value register 12 when a long loop is encountered. This history value starts to build up with a succession of continuous branch taken outcomes being recorded. When these completely fill the history value, then a switch is made to the second mode in which the history value is set to all “0”s. A count value then starts to be made in the leftmost five bits of the history value. When the first branch not taken outcome is predicted, or actually occurs, then a switch is made back to the first mode with the history being represented by a continuous sequence of branch taken bits terminated by a single branch not taken bit.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. Apparatus for processing data, said apparatus comprising:
a pipelined processing circuit operable to execute program instructions including conditional branch instructions generating branch outcomes; and
a branch prediction circuit operable to generate predictions of branch outcomes of conditional branch program instructions to be executed by said pipelined processing circuit; and
a prefetch circuit operable to supply a stream of program instructions to said pipelined processing circuit for execution in dependence upon said predictions; wherein
said branch prediction circuit comprises:
a branch history register operable to store a branch history value indicative of a preceding sequence of branch outcomes;
a branch prediction memory having prediction memory storage locations addressed in dependence upon at least said branch history value, a prediction memory storage location addressed by a given branch history value being operable to store a prediction of a branch outcome for a next conditional branch instruction following a given preceding sequence of branch outcomes corresponding to said given branch history value; and
a history value generating circuit operable to generate a history value to be stored within said history register in dependence upon a new branch outcome generated by execution of a new conditional branch instruction by said pipelined processing circuit in accordance with:
a first history value mode in which a stored history value represents a preceding sequence of conditional branch instructions that resulted in a mixture of branch taken outcomes and branch not taken outcomes by respective bits within said history value; and
a second history value mode in which a stored history value represents a preceding sequence of conditional branch instructions that resulted in a continuous sequence of branch taken outcomes of greater than a predetermined length by a count value within said history value.

2. Apparatus as claimed in claim 1, wherein said history value update circuit switches from said first history value mode to said second history value mode when a continuous sequence of branch taken outcomes greater than said predetermined length is detected.

3. Apparatus as claimed in claim 1, wherein said history value update circuit switches from said second history value mode to said first history value mode when a branch not taken outcome is detected.

4. Apparatus as claimed in claim 1, wherein:
in said first history value mode said history value is updated by shifting said history value one bit position from a first end toward a second end and adding a bit corresponding to said new branch outcome to said first end; and
in said second history value mode said count value extends from said second end toward said first end.

5. Apparatus as claimed in claim 4, wherein in said second history value mode bits between a most significant bit of said count value and said first end have bit values corresponding to branch not taken outcomes within said first history value mode.

6. Apparatus as claimed in claim 4, wherein said count value has a predetermined maximum bit length that is less than a bit length of said history value.

7. A method of processing data, said method comprising the steps of:
executing program instructions including conditional branch instructions generating branch outcomes with a pipelined processing circuit; and
generating predictions of branch outcomes of conditional branch program instructions to be executed by said pipelined processing circuit with a branch prediction circuit; and
supplying a stream of program instructions to said pipelined processing circuit for execution in dependence upon said predictions with a prefetch circuit; wherein
said step of prediction comprises:
storing a branch history value indicative of a preceding sequence of branch outcomes;
addressing prediction memory storage locations within a branch prediction memory in dependence upon at least said branch history value, a prediction memory storage location addressed by a given branch history value being operable to store a prediction of a branch outcome for a next conditional branch instruction following a given preceding sequence of branch outcomes corresponding to said given branch history value; and
generating a history value to be stored within said history register in dependence upon a new branch outcome generated by execution of a new conditional branch instruction by said pipelined processing circuit in accordance with:
a first history value mode in which a stored history value represents a preceding sequence of conditional branch instructions that resulted in a mixture of branch taken outcomes and branch not taken outcomes by respective bits within said history value; and
a second history value mode in which a stored history value represents a preceding sequence of conditional branch instructions that resulted in a continuous sequence of branch taken outcomes of greater than a predetermined length by a count value within said history value.

8. A method as claimed in claim 7, comprising switching from said first history value mode to said second history value mode when a continuous sequence of branch taken outcomes greater than said predetermined length is detected.

9. A method as claimed in claim 7, comprising switching from said second history value mode to said first history value mode when a branch not taken outcome is detected.

10. A method as claimed in claim 7, wherein:
in said first history value mode said history value is updated by shifting said history value one bit position from a first end toward a second end and adding a bit corresponding to said new branch outcome to said first end; and
in said second history value mode said count value extends from said second end toward said first end.

11. A method as claimed in claim 10, wherein in said second history value mode bits between a most significant bit of said count value and said first end have bit values corresponding to branch not taken outcomes within said first history value mode.

12. A method as claimed in claim 10, wherein said count value has a predetermined maximum bit length that is less than a bit length of said history value.
